(19) United States
(12) Patent Application Publication
(10) Pub. No.: US 2019/0156366 A1
(43) Pub. Date: May 23, 2019

(54) IDENTIFYING ACTIONS FOR DIFFERENT GROUPS OF USERS AFTER PRESENTATION OF A CONTENT ITEM TO THE GROUPS OF USERS

(71) Applicant: Facebook, Inc., Menlo Park, CA (US)

(72) Inventors: Mairin Gates Wilson, San Francisco, CA (US); Edward Philip Trezise, Los Angeles, CA (US); Renato Igor Santos, San Mateo, CA (US)

(21) Appl. No.: 15/817,130

(22) Filed: Nov. 17, 2017

(51) Int. Cl. G06Q 30/02; G06Q 10/06; G06N 7/00; G06N 5/04

(52) U.S. Cl. CPC G06Q 30/0254; G06Q 30/0249; G06N 5/04; G06Q 30/0277; G06N 7/005; G06Q 10/067

(57) ABSTRACT

An online system maintains various models each corresponding to an action, with a model determining a likelihood of an online system user performing the action after being presented with content. A publishing user provides the online system with a content item for presentation to users of the online system and with information identifying sets of users to be presented with the content item. Different sets of users have one or more differing characteristics. The online system applies various models to identified users in each set to determine likelihoods of users in each set performing actions corresponding to different models after being presented with the content item. Based on the likelihoods, the online system selects actions for each set and presents the publishing user with information identifying actions selected for each set.

### BACKGROUND

This disclosure relates generally to presenting content to users of an online system, and more specifically to identifying actions performed by groups of users of the online system after being presented with a content item.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to provide content to the online system for presentation to other online system users. This allows the publishing user to leverage the online system to gain public attention for the publishing user's products or services or to persuade other users to take an action regarding the publishing user's products or services. However, different online system users may be more inclined to perform different actions when presented with a content item from a publishing user. Conventionally, publishing users have limited information describing actions performed by various online system users after being presented with a content item. While the publishing user may identify specific users to be presented with a content item by providing targeting criteria along with the content item to the online system, the publishing user may provide content items tailored to entice users into performing actions that the users are unlikely to perform or that have more limited value to the publishing user. This less efficient presentation of content items to users may deter a publishing user from subsequently providing content to the online system for presentation.

### SUMMARY

An online system presents various content items to its users. In various embodiments, the online system obtains content items from a user and includes the content items in one or more selection processes selecting content for presentation to other online system users. A user providing content items to the online system associates an objective with various content items. An objective associated with a content item specifies an interaction the user providing the content item to the online system desires other users to perform when presented with the content item. Example objectives include: installing an application associated with a content item, indicating a preference for a content item, sharing a content item, interacting with an object associated with a content item, or performing any other suitable interaction. An objective may be associated with individual content items or may be associated with a campaign, which associates the objective with each content item in the campaign.

Additionally, the online system receives information identifying actions performed by users with content. The online system may receive the information from third party systems providing content to users of the online system or from applications executing on client devices in various embodiments. For example, information received by the online system identifies different actions a user performed with an application executing on a client device; the application may provide the information to the online system or a third party system receives the information from the application and subsequently provides the information to the online system. The information may identify actions by users with content while the content is presented to the user or actions by users after being presented with content. In various embodiments, information received by the online system identifies a user, an action performed by the user, and information identifying the content presented to the user when the user performed the action or prior to the user performing the action. The received information may also identify a time when the identified content was presented to the user as well as a time when the user performed the identified action.

Based on the received information, the online system generates multiple models that each correspond to an action. A model determines a likelihood of a user of the online system performing an action corresponding to the model after content is presented to the user based on characteristics of the user and characteristics of the content presented to the user. The online system may generate the models using any suitable method or methods in various embodiments. For example, each model is a machine learned model trained based on received information describing actions performed by users after being presented with various content. Using the received information identifying user actions with presented content to generate the models allows the models to more accurately determine likelihoods of various user actions. The online system stores the generated models in association with their corresponding actions.

Actions corresponding to different models may have varying levels of specificity. Certain actions are specific actions with presented content or after being presented with content. Examples of specific actions include performing a particular action with an application or with presented content, installing an application identified by content, and performing a particular action (e.g., indicating a preference for presented content, sharing presented content with another user, providing a comment on presented content). Actions corresponding to other models may be broader, such as viewing the content or viewing a threshold amount of the content. Accordingly, a specific action is described by a greater number of criteria than a broader action. Hence, specific actions are typically performed by users less frequently than broader actions.

The online system receives a content item from a publishing user along with information identifying sets of users eligible to be presented with the content item. The online system may receive any suitable information to identify a set of users. For example, the online system receives demographic information identifying a set of users to indicate users having characteristics matching at least a threshold amount of the demographic information are eligible to be presented with the content item. As another example, the online system receives one or more interests identifying a set of users indicating users having at least a threshold amount of the interests included in a user profile maintained by the online system are eligible to be presented with the content item. In other examples, the online system receives one or more actions performed by users or connections between users and other users or objects maintained by the online system to identify a set of users. In another example, the online system receives information identifying a target group of users and a measure of similarity indicating that users having at least the threshold measure of similarity to the target group of users are eligible to be presented with the content item.

Based on characteristics of users maintained by the online system, the online system identifies users included in each set received from the publishing user. For a set identified by demographic information, the online system retrieves information stored in user profiles for various users and identifies users having at least a threshold amount of the demographic information in a stored user profile. Similarly, for a set identified by one or more interests, the online system identifies users having at least a threshold amount of the interests in user profiles corresponding to the users. If a set is identified based on actions performed by users or one or more connections to one or more users or to one or more objects, the online system identifies users the online system identifies as having performed the action or users the online system identifies as having the connections to one or more other users or to one or more objects. For a set identified by a measure of similarity to a target group, the online system identifies users having at least the threshold measure of similarity to the target group.

For each set of users identified by the information received from the publishing user, the online system applies models corresponding to each of at least a set of actions to characteristics of users identified as included in each set of users. Applying a model corresponding to an action to characteristics of users identified as included in a set of users determines likelihoods of users of the set performing the action when presented with the content item. In various embodiments, the online system applies models corresponding to each of at least the set of actions to users of a set to determine likelihoods of users of the set performing each action of the set of actions. Alternatively, the online system applies models corresponding to each action to users of a set to determine likelihoods of users of the set performing each action. The online system determines likelihoods of a subset of users of a set of users performing various actions in some embodiments.

Based on the determined likelihoods of users included in each set of users performing different actions, the online system selects an action for each set of users. For example, the online system determines an average likelihood of users in a set of users performing various actions based on the determined likelihoods and selects an action for the set of users having a maximum average likelihood. In other embodiments, different sets of users include different numbers of users, and the online system accounts for a number of users in a set of users when selecting and action for the set of users. For example, the online system selects more specific actions (i.e., actions identified by a greater number of criteria) for sets of users including a relatively larger number of users than other sets of users and selects more broad actions (i.e., actions identified by fewer number of criteria) for sets of users including a relatively smaller number of users than other sets of users. In various embodiments, the online system ranks the sets of users based on numbers of users included in each set of users and ranks the actions based on amounts of specificity. For a set of users having a position in the ranking, the online system identifies actions within a range of positions in the ranking of actions and selects an action within the range of positions having a maximum determined likelihood for the set of users.

In some embodiments, the information received by the online system identifying the sets of users includes a relative ranking of the sets of users by the publishing user. The publishing user may base the relative ranking of the sets of users on any suitable combination of criteria. The online system may account for the relative ranking of the sets of users when selecting actions for each set of users based on the determined likelihoods of users included in each set of users performing various actions. For example, the relative ranking of sets of users specifies a value to the publishing user of different sets of users performing an action. The online system selects actions for each set of users that maximizes a total expected value for the sets of users, where an expected value for a set of users is a product of a likelihood of users of the set performing an action and the value of the set of users to the publishing user.

The online system presents information identifying each set of users in association with and an action selected for each set to the publishing user. For example, the online system presents information identifying a set of users received from the publishing user in association with the action selected for the set of users. In various embodiments, the online system receives a budget from the publishing user along with the content item and the information identifying the sets of users. The budget specifies a total amount of compensation the publishing user will provide to the online system in exchange for presentation of the content item to online system users. Based on the actions selected for different sets of users, the online system determines portions of the budgets allocated to different sets of users and presents a portion of the budget allocated for a set of users in association with information identifying the set of users. For example, the online system allocations portions of the budget to different sets based on average likelihoods of users of different sets of users performing actions selected for the different sets of users. In various embodiments, the online system allocates a portions of the budget to a set of users based on an average likelihood of users of the set performing the action selected for the set. For example, portions of the budget allocated to different sets of users are directly related to average likelihoods of users of the sets performing the actions selected for the sets of users, so larger portions of the budget are allocated to sets of users for which actions having a higher average likelihood of being performed, relative to average likelihoods of users of other sets of users performing the actions selected for the other sets of users.

Accordingly, the online system presents information identifying actions most likely to be performed by the different sets of users when presented with the content item. Accordingly, the publishing user may specify a different objective for the content item for different sets of users based on the actions selected by the online system for the different sets of users. An objective associated with a content item specifies an interaction the publishing user providing desires other users to perform when presented with the content item. Example objectives include: installing an application associated with the content item, indicating a preference for the content item, sharing the content item, interacting with an object associated with the content item, performing an action with the application associated with the content item, or performing any other suitable action. The publishing user may accordingly provide compensation to the online system when a user presented with the content item performs the objective. Specifying different objectives for groups of users having different characteristics allows the publishing user to more effectively allocate compensation to the online system for presenting the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for identifying actions to associate with presentation of a content item to different sets of users of an online system, in accordance with an embodiment.

FIG. 4 is an example selection of actions for groups of users, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

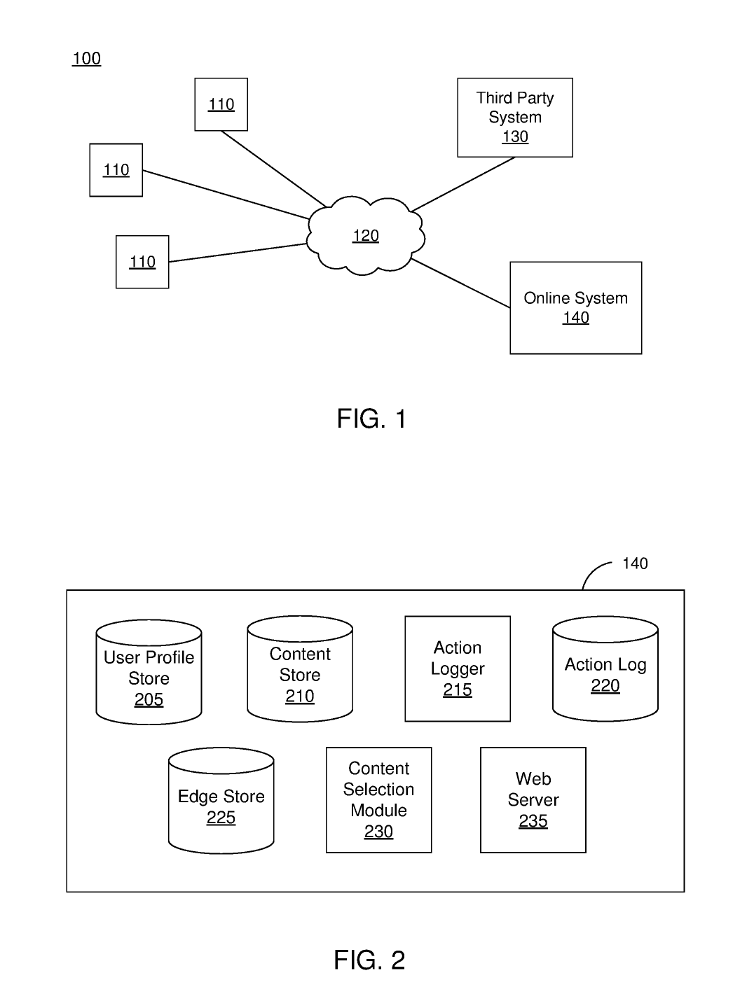

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

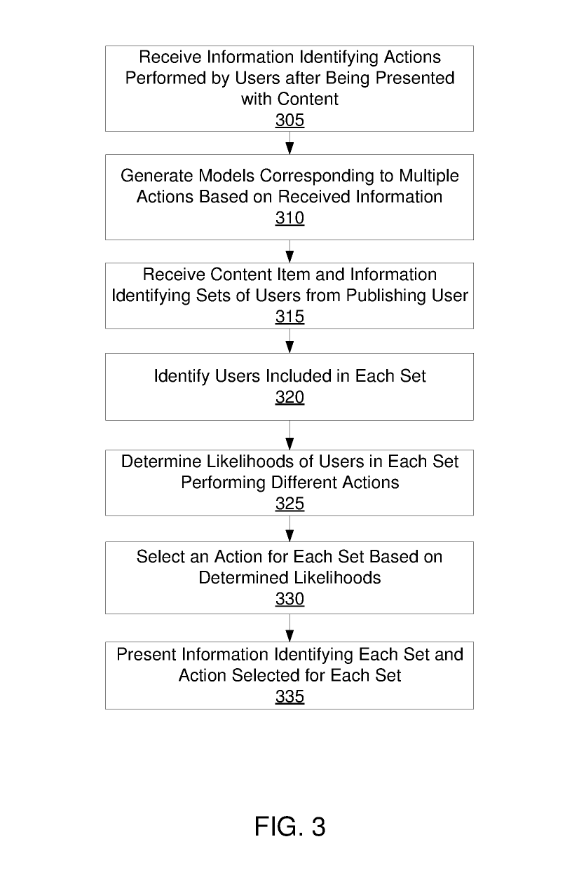

As further described below in conjunction with FIG. 3, the content selection module 230 maintains various models each corresponding to an action, with a model determining a likelihood of an online system user performing the action after being presented with content. Different models are determined by the content selection module 230 based on information the content selection module 230 received from third party systems 130 or from applications executing on client devices 110 describing actions performed by users of the online system 140 after being presented with content. The content selection module 230 receives a content item from a publishing user and information identifying different sets of users, where different sets of users have at least one different characteristic. As further described below in conjunction with FIG. 3, the content selection module 230 identifies users included in each set of users and applies models corresponding to different actions to users included in each set of users. Based on the likelihoods of users in different sets performing actions corresponding to different applied models, the content selection module 230 selects an action for each set of users, as further described below in conjunction with FIG. 3. The content selection module 230 presents information identifying different sets of users along with an action selected for each set of users to the publishing user, allowing the publishing user to specify or to modify compensation provided by the publishing user to the online system 140 for presenting the content item.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Identifying Actions for Different Sets of Users after being Presented with a Content Item

FIG. 3 is a flowchart of one embodiment of a method for identifying actions to associate with presentation of a content item to different sets of users of an online system 140. In other embodiments, the method may include different and/or additional steps than those shown in FIG. 3. Additionally, steps of the method may be performed in different orders than the order described in conjunction with FIG. 3 in various embodiments.

An online system 140 receives 305 information identifying actions performed by users with content. The online system 140 may receive 305 the information from third party systems 130 providing content to users of the online system 140 or from applications executing on client devices 110 in various embodiments. For example, information received 305 by the online system 140 identifies different actions a user performed with an application executing on a client device 110; the application may provide the information to the online system 140 or a third party system 130 receives the information from the application and subsequently provides the information to the online system 140. The information may identify actions by users with content while the content is presented to the user or actions by users after being presented with content. In various embodiments, information received by the online system 140 identifies a user, an action performed by the user, and information identifying the content presented to the user when the user performed the action or prior to the user performing the action. The received information may also identify a time when the identified content was presented to the user as well as a time when the user performed the identified action.

Based on the received information, the online system 140 generates 310 multiple models that each correspond to an action. A model determines a likelihood of a user of the online system 140 performing an action corresponding to the model after content is presented to the user based on characteristics of the user and characteristics of the content presented to the user. The online system 140 may generate the models using any suitable method or methods in various embodiments. For example, each model is a machine learned model trained based on received 305 information describing actions performed by users after being presented with various content. Using the received information identifying user actions with presented content to generate 310 the models allows the models to more accurately determine likelihoods of various user actions. The online system 140 stores the generated models in association with their corresponding actions.

Actions corresponding to different models may have varying levels of specificity. Certain actions are specific actions with presented content or after being presented with content. Examples of specific actions include performing a particular action with an application or with presented content, installing an application identified by content, and performing a particular action (e.g., indicating a preference for presented content, sharing presented content with another user, providing a comment on presented content). Actions corresponding to other models may be broader, such as viewing the content or viewing a threshold amount of the content. Accordingly, a specific action is described by a greater number of criteria than a broader action. Hence, specific actions are typically performed by users less frequently than broader actions.

The online system 140 receives 315 a content item from a publishing user along with information identifying sets of users eligible to be presented with the content item. The online system 140 may receive 315 any suitable information to identify a set of users. For example, the online system 140 receives 315 demographic information identifying a set of users to indicate users having characteristics matching at least a threshold amount of the demographic information are eligible to be presented with the content item. As another example, the online system 140 receives 315 one or more interests identifying a set of users indicating users having at least a threshold amount of the interests included in a user profile maintained by the online system 140 are eligible to be presented with the content item. In other examples, the online system 140 receives 315 one or more actions performed by users or connections between users and other users or objects maintained by the online system 140 to identify a set of users.

In another example, the online system 140 receives 315 information identifying a target group of users and a measure of similarity indicating that users having at least the threshold measure of similarity to the target group of users are eligible to be presented with the content item. To identify users having at least a threshold measure of similarity to an identified target group, the online system 140 generates a cluster group for the content item that includes users who do not have characteristics matching at least a threshold number or a threshold percentage of characteristics common to the target group. Users in the cluster group have at least a threshold affinity for, or a threshold likelihood of interacting with, the content item. The online system 140 generates a cluster model for the content item based on characteristics of users in the target group received 315 from the publishing user. The cluster model includes cluster model parameters applied to various characteristics of a user who is not in the target group. For example, cluster model parameters are weights corresponding to different characteristics of the user, and the cluster model combines the weights to obtain a cluster score for the user. Different cluster model parameters are determined from weights associated with users in the target group (i.e., users having characteristics satisfying at least a threshold number or a threshold percentage of the characteristics of users in the target group) or from weights associated with characteristics by the one or more rules associated with the target group. For example, the online system 140 may determine cluster model parameters applied to characteristics of users having less than a threshold number or threshold amount of characteristics matching characteristics of users in the target group as described in U.S. patent application Ser. No. 13/297,117, filed on Nov. 15, 2011, or in U.S. patent application Ser. No. 14/290,355, filed on May 29, 2014, each of which is hereby incorporated by reference in its entirety. In various embodiments, the online system 140 generates the cluster model so a sum of the cluster model parameters is maximized or so a sum of characteristics weighted by the cluster model parameters is maximized. Additionally, the online system 140 may determine cluster model parameters for characteristics based on characteristics of users in the target group, as further described in U.S. patent application Ser. No. 13/297,117, filed on Nov. 15, 2011, or in U.S. patent application Ser. No. 14/290,355, filed on May 29, 2014, each of which is hereby incorporated by reference in its entirety.

The online system 140 stores the cluster model in association with the content item. For example, the online system 140 stores the cluster model in association with an identifier of the content item. Subsequently, the online system 140 generates cluster scores for one or more users who are not included in the target group by applying the cluster model to one or more users who do not have characteristics matching at least as threshold number or a threshold amount of characteristics common to users of the target group. For example, a cluster score for a user is a combination of the cluster model parameters corresponding to characteristics of the user. In some embodiments, the online system 140 identifies users in the target group received 315 along with the content item and generates cluster scores for multiple users who are not in the target group by applying the cluster model to characteristics of the users.

Based on a cluster score generated for a user who does not have characteristics matching at least a threshold number or a threshold amount of characteristics of users of the target group, the online system 140 determines if the user has at least a threshold measure of similarity to the target group. In various embodiments, the online system 140 maintains cluster group cutoff scores corresponding to different measures of similarity and determines the user has at least a measure of similarity to the target group if the cluster score for the user equals or exceeds a cluster group cutoff score corresponding to the measure of similarity to the target group and determines the user has less than the threshold measure of similarity to the target group if the cluster score for the user is less than the cluster group cutoff score corresponding to the measure of similarity. The online system 140 may determine the cluster group cutoff score corresponding to a measure of similarity using any suitable method, such as the method further described in U.S. patent application Ser. No. 14/290,355, filed on May 29, 2014, which is hereby incorporated by reference in its entirety.

Based on characteristics of users maintained by the online system 140, the online system 140 identifies 320 users included in each set received 315 from the publishing user. For a set identified by demographic information, the online system 140 retrieves information stored in user profiles for various users and identifies 320 users having at least a threshold amount of the demographic information in a stored user profile. Similarly, for a set identified by one or more interests, the online system 140 identifies 320 users having at least a threshold amount of the interests in user profiles corresponding to the users. If a set is identified based on actions performed by users or one or more connections to one or more users or to one or more objects, the online system 140 identifies 320 users the online system 140 identifies as having performed the action or users the online system 140 identifies as having the connections to one or more other users or to one or more objects. For a set identified by a measure of similarity to a target group, the online system 140 identifies 320 users having at least the threshold measure of similarity to the target group as further described above.

For each set of users identified by the information received 315 from the publishing user, the online system 140 applies models corresponding to each of at least a set of actions to characteristics of users identified 320 as included in each set of users. Applying a model corresponding to an action to characteristics of users identified 320 as included in a set of users determines 325 likelihoods of users of the set performing the action when presented with the content item. In various embodiments, the online system 140 applies models corresponding to each of at least the set of actions to users of a set to determine 325 likelihoods of users of the set performing each action of the set of actions. Alternatively, the online system 140 applies models corresponding to each actions to users of a set to determine 325 likelihoods of users of the set performing each action. The online system 140 determines 325 likelihoods of a subset of users of a set of users performing various actions in some embodiments.

Based on the determined likelihoods of users included in each set of users performing different actions, the online system 140 selects 330 an action for each set of users. For example, the online system 140 determines an average likelihood of users in a set of users performing various actions based on the determined likelihoods and selects 330 an action for the set of users having a maximum average likelihood. In other embodiments, different sets of users include different numbers of users, and the online system 140 accounts for a number of users in a set of users when selecting 330 and action for the set of users. For example, the online system 140 selects 330 more specific actions (i.e., actions identified by a greater number of criteria) for sets of users including a relatively larger number of users than other sets of users and selects 330 more broad actions (i.e., actions identified by fewer number of criteria) for sets of users including a relatively smaller number of users than other sets of users. In various embodiments, the online system 140 ranks the sets of users based on numbers of users included in each set of users and ranks the actions based on amounts of specificity. For a set of users having a position in the ranking, the online system 140 identifies actions within a range of positions in the ranking of actions and selects 330 an action within the range of positions having a maximum determined likelihood for the set of users.

In some embodiments, the information received 315 by the online system 140 identifying the sets of users includes a relative ranking of the sets of users by the publishing user. The publishing user may base the relative ranking of the sets of users on any suitable combination of criteria. The online system 140 may account for the relative ranking of the sets of users when selecting 330 actions for each set of users based on the determined likelihoods of users included in each set of users performing various actions. For example, the relative ranking of sets of users specifies a value to the publishing user of different sets of users performing an action. The online system 140 selects 330 actions for each set of users that maximizes a total expected value for the sets of users, where an expected value for a set of users is a product of a likelihood of users of the set performing an action and the value of the set of users to the publishing user.

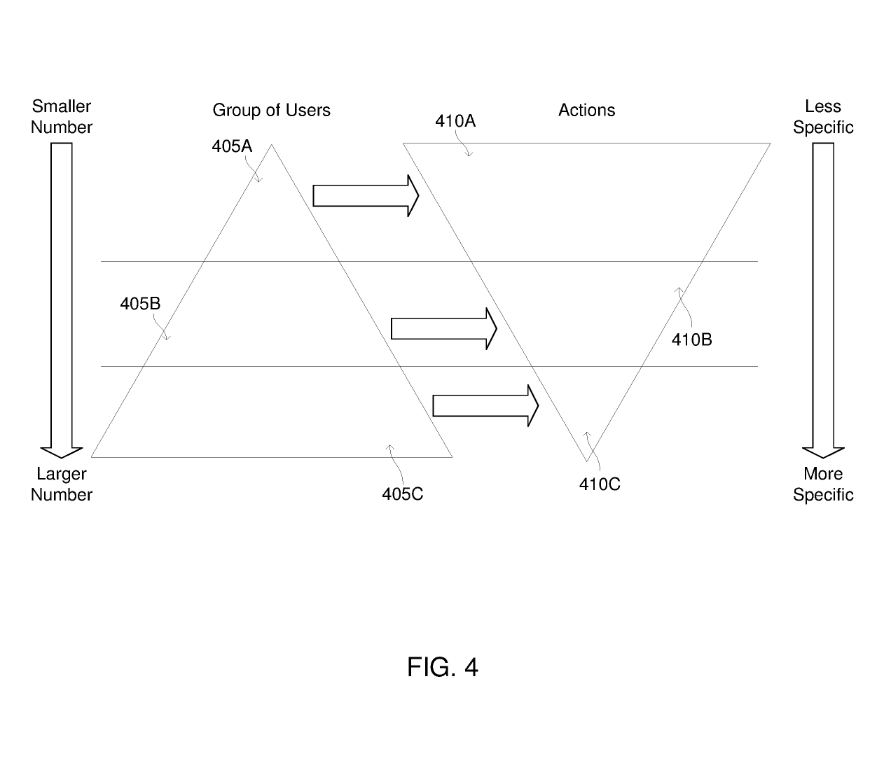

FIG. 4 shows an example of selecting actions for groups of users. In the example of FIG. 4, the online system 140 accounts for numbers of users in different groups of users when selecting actions for groups of users. As shown in FIG. 4, the online system 140 selects more specific actions for groups of users including larger number of users. Hence, for group 405A of users, which includes relatively fewer number of users than group 405B and group 405C, the online system 140 selects action 410A, which is specified by a fewer number of criteria than other actions. For example, group 405A of users is identified as having at least a threshold similarity to a target group, and the online system 140 selects an action 410A described by relatively fewer criteria, such as viewing the content item, than action 410B and action 410C having a maximum likelihood of being performed by users when presented with the content item. For group 405B of users, which includes a greater number of users than group 405A of users but a smaller number of users than group 405C, the online system 140 selects action 410B, which is specified by more criteria than action 410A but fewer criteria than action 410C. As an example, group 405B is specified by one or more interests in a user profile of a user, and action 405B is installation of an application associated with the content item. In FIG. 4, group 405C includes a greater number of users than group 405A and group 405B, so the online system 140 selects action 410C for group 405C, where action 410C is specified by more criteria than action 410A and action 410B. In a specific example, group 405C is specified by demographic information included in user profiles, and action 410C is performing a specific interaction with an application associated with the content item.

Referring back to FIG. 3, the online system 140 presents 335 information identifying each set of users in association with and an action selected for each set to the publishing user. For example, the online system 140 presents 335 information identifying a set of users received 315 from the publishing user in association with the action selected for the set of users. In various embodiments, the online system 140 receives 315 a budget from the publishing user along with the content item and the information identifying the sets of users. The budget specifies a total amount of compensation the publishing user will provide to the online system 140 in exchange for presentation of the content item to online system users. Based on the actions selected 330 for different sets of users, the online system 140 determines portions of the budgets allocated to different sets of users and presents 335 a portion of the budget allocated for a set of users in association with information identifying the set of users. For example, the online system 140 allocations portions of the budget to different sets based on average likelihoods of users of different sets of users performing actions selected 330 for the different sets of users. In various embodiments, the online system 140 allocates a portions of the budget to a set of users based on an average likelihood of users of the set performing the action selected 330 for the set. For example, portions of the budget allocated to different sets of users are directly related to average likelihoods of users of the sets performing the actions selected 330 for the sets of users, so larger portions of the budget are allocated to sets of users for which actions having a higher average likelihood of being performed, relative to average likelihoods of users of other sets of users performing the actions selected 330 for the other sets of users.

Accordingly, the online system 140 presents 335 information identifying actions most likely to be performed by the different sets of users when presented with the content item. Accordingly, the publishing user may specify a different objective for the content item for different sets of users based on the actions selected 330 by the online system 140 for the different sets of users. An objective associated with a content item specifies an interaction the publishing user providing desires other users to perform when presented with the content item. Example objectives include: installing an application associated with the content item, indicating a preference for the content item, sharing the content item, interacting with an object associated with the content item, performing an action with the application associated with the content item, or performing any other suitable action. The publishing user may accordingly provide compensation to the online system 140 when a user presented with the content item performs the objective. Specifying different objectives for groups of users having different characteristics allows the publishing user to more effectively allocate compensation to the online system 140 for presenting the content item.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, information identifying actions by users taken based on content presented to the users;
generating, at the online system, a plurality of models from the identified actions by users with content presented to the user, each model corresponding to an action with content and determining likelihoods of users of the online system performing the action when presented with content based on characteristics of the users and characteristics of the content;
receiving a content item and information identifying sets of users eligible to be presented with the content item from a publishing user, different sets of users having one or more differing characteristics;
identifying users in each set based on characteristics of users maintained by the online system;
determining likelihoods of users in each set performing each of one or more actions when presented with the content item by applying a model corresponding to each of the one or more actions to identified users in each set;
selecting an action for each set based on the determined likelihoods; and
presenting information identifying each set of users in association with the action selected for each set of users to the publishing user.

2. The method of claim 1, wherein each set includes a different number of identified users.

3. The method of claim 2, wherein selecting action model for each set based on the determined likelihoods comprises:
selecting a specific action for a set including a greater number of identified users relative to numbers of identified users included in one or more other sets.

4. The method of claim 1, wherein the action with content is selected from a group consisting of: viewing the content, installing an application associated with the content after being presented with the content, performing an interaction with the application after installation of the application, and any combination thereof.

5. The method of claim 1, wherein information identifying sets of users eligible to be presented with the content item is selected from a group consisting of: a measure or similarity with a target group of users identified by the publishing user, an interest, demographic information, a location, and any combination thereof.

6. The method of claim 1, wherein selecting the action for each set based on the determined likelihoods comprises:
determining a number of identified users included in each set; and
selecting the action for a set based on the determined likelihoods and the number of identified users included in the set.

7. The method of claim 1, wherein receiving the content item and information identifying sets of users eligible to be presented with the content item from the publishing user further comprises receiving a relative ranking of the sets of users to the publishing user.

8. The method of claim 7, wherein selecting the action for each set based on the determined likelihoods comprises:
selecting the action for a set based on the determined likelihoods and the relative ranking of the sets of users to the publishing user.

9. The method of claim 1, wherein receiving the content item and information identifying sets of users eligible to be presented with the content item from the publishing user further comprises receiving a budget for presenting the content item via the online system.

10. The method of claim 9, wherein presenting information identifying each set of users in association with and the action selected for each set of users to the publishing user comprises:
determining a portion of the budget for presenting the content item to each of the sets of users based on the budget and an average likelihood of users in each set of users performing the action selected for each set of users.

11. A computer program product comprising a computer readable storage medium having instructions encoded thereon that, when executed by a processor, cause the processor to:
receive, at an online system, information identifying actions by users taken based on content presented to the users;
generate, at the online system, a plurality of models from the identified actions by users with content presented to the user, each model corresponding to an action with content and determining likelihoods of users of the online system performing the action when presented with content based on characteristics of the users and characteristics of the content;
receive a content item and information identifying sets of users eligible to be presented with the content item from a publishing user, different sets of users having one or more differing characteristics;
identify users in each set based on characteristics of users maintained by the online system;
determine likelihoods of users in each set performing each of one or more actions when presented with the content item by applying a model corresponding to each of the one or more actions to identified users in each set;
select an action for each set based on the determined likelihoods; and
present information identifying each set of users in association with the action selected for each set of users to the publishing user.

12. The computer program product of claim 11, wherein each set includes a different number of identified users.

13. The computer program product of claim 12, wherein select action model for each set based on the determined likelihoods comprises:
select specific action for a set including a greater number of identified users relative to numbers of identified users included in one or more other sets.

14. The computer program product of claim 11, wherein the action with content is selected from a group consisting of: viewing the content, installing an application associated with the content after being presented with the content, performing an interaction with the application after installation of the application, and any combination thereof.

15. The computer program product of claim 11, wherein information identifying sets of users eligible to be presented with the content item is selected from a group consisting of: a measure or similarity with a target group of users identified by the publishing user, an interest, demographic information, a location, and any combination thereof.

16. The computer program product of claim 11, wherein select the action for each set based on the determined likelihoods comprises:
determine a number of identified users included in each set; and
select the action for a set based on the determined likelihoods and the number of identified users included in the set.

17. The computer program product of claim 11, wherein receive the content item and information identifying sets of users eligible to be presented with the content item from the publishing user further comprises receiving a relative ranking of the sets of users to the publishing user.

18. The computer program product of claim 17, wherein select the action for each set based on the determined likelihoods comprises:
select the action for a set based on the determined likelihoods and the relative ranking of the sets of users to the publishing user.

19. The computer program product of claim 11, wherein receive the content item and information identifying sets of users eligible to be presented with the content item from the publishing user further comprises receiving a budget for presenting the content item via the online system.

20. The computer program product of claim 19, wherein present information identifying each set of users in association with and the action selected for each set of users to the publishing user comprises:
determine a portion of the budget for presenting the content item to each of the sets of users based on the budget and an average likelihood of users in each set of users performing the action selected for each set of users.
